(19) United States
(12) Patent Application Publication
(10) Pub. No.: US 2009/0256395 A1
(43) Pub. Date: Oct. 15, 2009

(54) Cockpit of Vehicle with Adaptable Opening

(76) Inventors: Frederic Naud, Paris (FR); Jean Michael Naud, Paris (FR)

Correspondence Address: Jean Naud, 5 Rue de I'amiral Roussin, Paris, FR

(21) Appl. No.: 12/227,139

(22) PCT Filed: Mar. 23, 2007
(86) PCT No.: PCT/FR2007/000502

§ 371 Date: Mar. 6, 2009

(30) Foreign Application Priority Data
Apr. 4, 2006 (FR) 0602906

(51) Int. Cl. B62D 31/00; B62D 25/00; B62D 63/02

(52) U.S. Cl. 296/190.11

(57) ABSTRACT

The present invention relates to a cabin (10) of a vehicle (1) defining an internal volume, which houses at least the driver's seat (40) and the driving controls (60, 61, 63), and comprising the superposition of a cabin base (15), a cabin frame bottom section (13), a cabin window (12), a cabin roof (14) and a permanent cabin opening, characterized in that the cabin is mounted by its cabin base (15) on a cabin support (50) comprising a slideway mounted on the vehicle chassis (3).

### TECHNICAL FIELD

The present invention relates to a Vehicle Cabin. This invention especially adapts to four-wheel urban vehicles and small cars designed for one or two people. The invention aims to offer maneuverability, agility and flexibility. The cabin offers a new ergonomic driving seat more reminiscent of motorcycle driving rather than the slightly elongated seat of a traditional car, giving the driver a slightly elevated position compared to roofs of nearby cars on the road. The cabin according to the invention will easily adapt to different conditions of use like weather, and location of use. The invention is especially suitable for urban driving and easy parking.

### BACKGROUND OF THE INVENTION

It is known to many small size four-wheel vehicles. Some sports cars are designed for all-terrain and offer almost the same ergonomic use of a motorcycle. These vehicles poorly protect the driver from the weather and are uneasily manageable in the city. They are designed for all-land with drivers commonly equipped with protective clothing. Electric cart vehicles for golf offer an open cabin poorly designed for weather protection. The car gasoline engine or electric two-seat offers a designed cabin on the basis of four door vehicles. This low cost cabin is adaptable to various weather conditions. There is no one or two seat vehicle which can be convertible or covered for driving with wind.

### DISCLOSURE OF THE INVENTION

The main objective of the invention is to propose a practical, manageable and flexible cabin for different meteorological conditions.

One objective of the invention is to propose a cabin which uses a minimum projected area on the ground to make the four-wheel vehicle as compact as possible. The compactness of this vehicle will allow it move more easily on the road among other vehicles.

An objective of the invention is to propose a four-wheel vehicle and his cabin for a single driver. This solution offers obvious savings while providing the driver with the same amenities of a traditional small car engine.

An object of the invention is to provide the driver with different functions—protection to rain and wind—driving comfort—driving wind—washing glass—ease of entry and exit in the cabin—

An object of the invention is to provide a cabin that is ergonomic and comfortable for the driver.

An object of the invention is to provide a cabin that offers maximum visibility.

An object of the invention is to provide a cabin that is protected from the wind as well as a driving wind.

An object of the invention is to provide a cabin which is efficient to manufacture. The invention proposes a cabin whose manufacturing requires a minimum of easily manufacturable parts. The assembling of parts between them to shape the driver cabin needs a minimum of human intervention. Under a preferential shape, the cabin shows the quality of strength for driver protection and quality of lightning for energy savings.

An object of the invention is to provide a cabin that provides a basis for ergonomic driving positioning the head of the driver at a height above the traditional hoods of vehicles, what provides comfort for driving and landscape appreciation

An object of the invention is to propose a cabin which meets the safety standards and features to protect the driver if he falls or crashes.

Fundamentally, the invention is composed of three elements that are a cabin hood, a cabin hood base and a driver seat. All these three elements work together to constitute a cabin with opening position and easily adaptable closing by the driver.

In one sense, the cabin has a general shape with vertical axial symmetry, significantly conical, and mounted over a circular cabin enclosure, with the driver seat in a way that corresponds with the cabin opening.

### DESCRIPTION OF THE DRAWINGS

Other objectives, characteristics, and advantages of the present invention will be demonstrated more clearly by the drawings included in this report.

FIG. 1 shows a general side view of the vehicle.

FIGS. 2a and 2b show a front view inside the vehicle in two specific positions of the cabin

FIGS. 3a, 3b, 3c and 3d show four views from the top of the cabin according to four specific dispositions

FIGS. 4a, 4b show a side and top view of the cabin.

FIGS. 5a, 5b show comprehensive views of the cabin base

FIGS. 6, 7 show specific views of equipments like the seat, the steering wheel, and the steering column, FIG. 6, the windshields, FIG. 7.

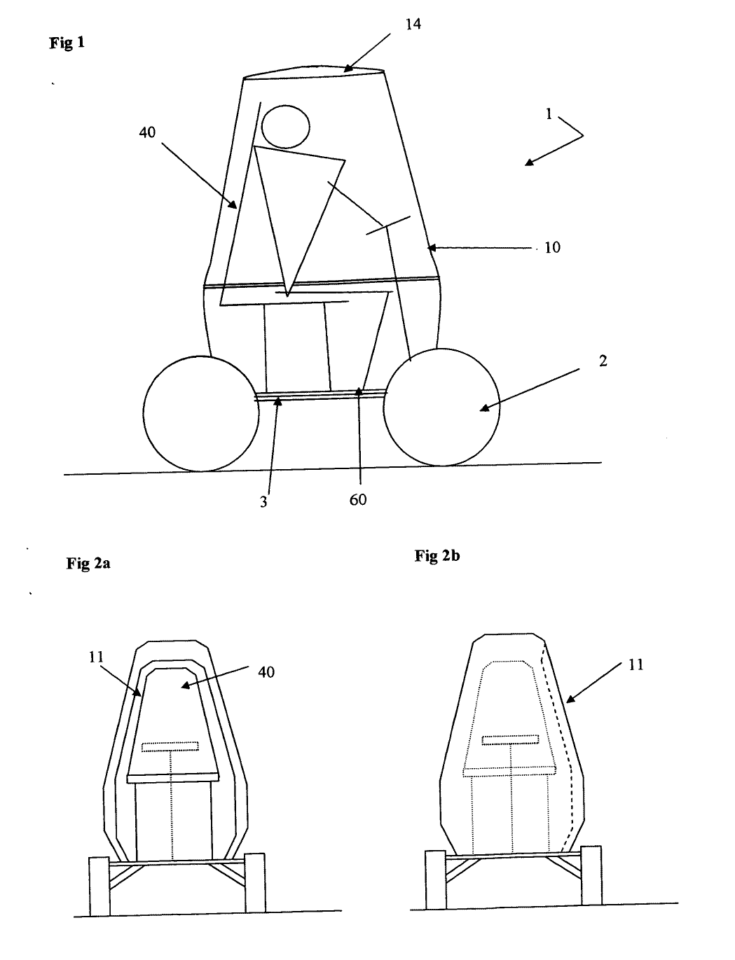

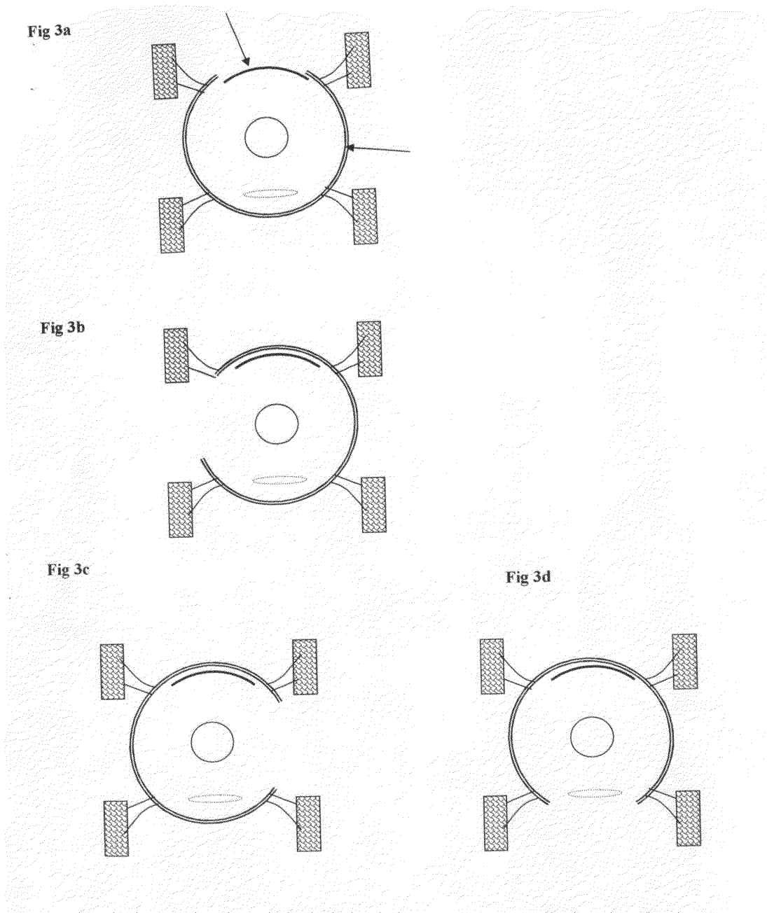

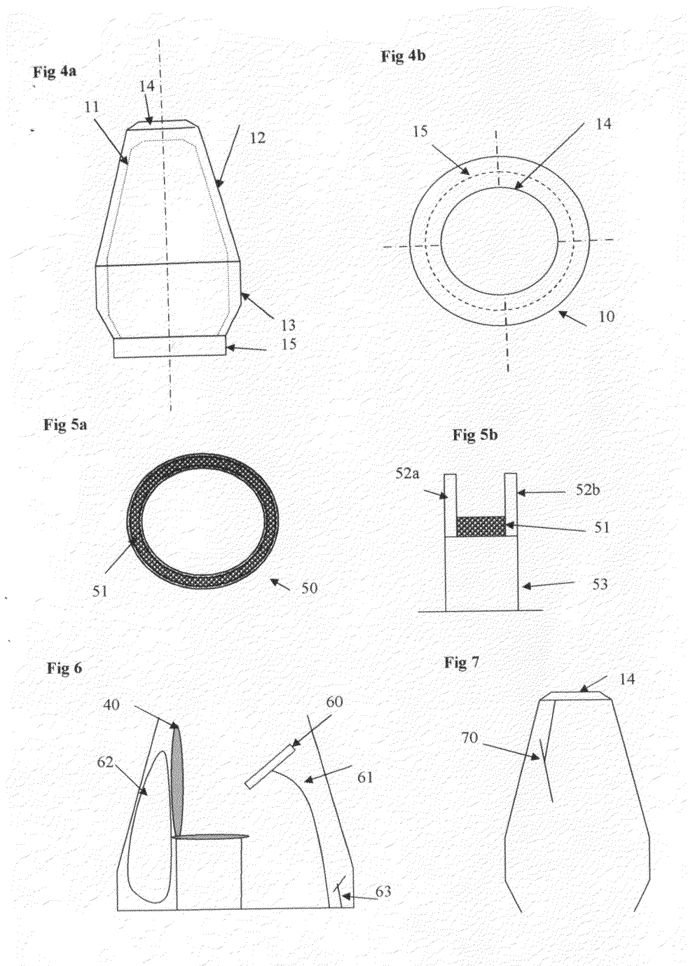

FIG. 1 shows a general side view of vehicle's (1) four wheels (2) mounted on a chassis (3). The driver's seat (40) in front of a steering wheel (60). A cabin (10) of oblong shape with a vertical axial symmetry surrounding the driver like a bubble, the seat (40), the driving commands, commands of the cabin opening, the steering wheel (60). FIGS. 2a and 2b show a front view of the vehicle in two different positions of the vehicle which show how the cabin hood curves, shaping the cabin opening (11) whose position is adaptable like explained in FIGS. 4a, 4b, 5a and 5b. The cabin opening (11) takes almost the entire height of the cabin (10) and almost the third of the cabin periphery. The cabin opening shape (11) matches the seat shape (40) so that the back of the seat block the cabin opening (11) in case where the cabin opening (11) is postured in front of the back seat (40) as showed in FIG. 2a viewed from the vehicle back, or FIG. 3a, viewed from the top. FIGS. 2b, a side view, and 3b, 3c a top view represent how the cabin opening (11) is shown on the lateral configuration (3) leaving room to the driver to enter into the cabin between the seat (40) and the steering wheel (60) to sit on the seat (40). According to the situation, the driver may either leave or enter the vehicle on the left or on the right by positioning the cabin opening (11) on the left or the night of the vehicle. FIG. 3d represents how the vehicle opening (11) located in front of the vehicle offers an especially pleasant into the wind driving in warm weather. An accessible lock from the vehicle or through the barrel of an accessible key as well from the outside of the vehicle allows the driver to lock in rotation in all positions the cabin (12, 13). FIGS. 4a, 4b show a side and top view of the cabin (10) which presents a general oblong shape with a vertical axial symmetry with a cabin base (15) with cylinder or conic shape, a cabin frame bottom section (13) mounted in the cabin base (15) until the height of the seat cushion (40) being conical from the lower exterior cabin to the top, (13) is the cabin window (12), above the cabin window (12) a cylinder of conic conical widening down, covered by the cabin roof (14) taking the shape of a small dish in the top of the cone in order to protect the driver from rain and sun. It is well understood that the cabin is easy to manufacture and economic, with four parts which are the cabin base (15) whose function is to link with the cabin mobile basis (53), a cabin frame bottom section (15) whose function is to represent a protected cabin namely for the driver legs, for example realized from a bended sheet metal, a cabin window (12) to provide visibility to the driver and whatever the angular position of the cabin opening (11). FIGS. 5a, 5b represent detailed views of the cabin support (50) positioned on the chassis (3) and of circular shape with a slide rail (51) composed of rolling ball or roller on which the cabin base (15) of complementary shape will slide. The cabin support has molds (52a, 52b) which come to retain and tighten the cabin base (15) to laterally or vertically retain it. The driver by running the cabin base (15) on the cabin support (50) positions the cabin opening in the selected position for driving, for getting in or out or for parking in the closed position. FIGS. 6, 7 show the equipment such as the seat (40) which leaves space in the rear and can be used in the electric version or as a spare fuel tank. The top seat can be transparent to provide visibility through the rear mirror. The steering wheel (60) and its steering column (61) match the design and the curve of the cabin window. The accelerator (63) is on the bottom. FIG. 7 represents how windshield wiper can be incorporated in the cabin roof (14) with a sweep the windshield wiper covers the periphery of the cabin window in a first version or 360° in another version.

### CONCLUSION

The invention relates to a cabin (10) for vehicle (1) characterized by an internal space that houses at least the driver seat (40) and the driving controls (60, 61, 63) including the superposition of a cabin (15), cabin frame bottom section (13), a cabin window (12) and a cabin roof (14) and a permanent cabin opening (11) characterized by the fact that the cabin (10) is mounted by its cabin base (15) on a cabin support (50) including a sliding rail (51) mounted on the vehicle (3) chassis (1)

The invention relates to a cabin (10) for vehicle (1) characterized by a cabin opening (11) adopts a matching shape to that of the seat back (40) so that the cabin opening (11) is positioned in front of the back seat (40), the space inside of the cabin is quite closed and protected from the weather outside.

The invention relates to a cabin (10) for vehicle (1) characterized by a slide rail (51) is circular.

The invention relates to a cabin (10) for vehicle (1) characterized by a cabin (10) presenting a vertical axial symmetry with the cabin frame bottom section (13) mounted in the cabin base (15) until the height of the seat (40) being conical from the lower exterior cabin to the top, (13) is the cabin window (12), above the cabin window (12) a cylinder of conic conical widening down, covered by the cabin roof (14) taking the shape of a small dish in the top of the cone in order to protect the driver from rain and sun.

The invention relates to a cabin (10) for vehicle (1) characterized by a windshield wiper which can be incorporated in the cabin roof (14) which runs the perimeter of the glass cabin.

The invention relates to a cabin (10) for vehicle (1) characterized by the cabin opening (11) takes almost the entire eight of the cabin (10) and about one third of the cabin periphery.

The invention thus relates to a cabin (10) for vehicle (1) characterized by a seat (40) that leave storage space in its rear.

The invention relates to a cabin (10) for vehicle (1) characterized by a column steering (61) the steering wheel (60) which is curved to match the design and the cabin glass curve.

The invention relates to a cabin (10) for vehicle (1) characterized by a cabin base (15) which can be rotated on a cabin enclosure (50), the driver positions the cabin enclosure (11) in the selected position selected for driving or for getting in or out or for parking in the closed position.

The invention relates to a cabin (10) for vehicle (1) characterized by the ergonomics of scooter seat positioning the head of the driver above the roof of traditional cars.

As described here many there are variations that combine themselves which can be brought here without ever leaving the framework of the invention defined below.

What I claim is:

1- Vehicle (1) cabin (10) defining an internal volume, which houses at least the drive's seat (40) driver and driving commands (60, 61, 63) and including the superposition of the cabin base (15), a cabin frame bottom section (13), a cabin glass (12) and a cabin roof (14) and a permanent cabin opening (11), the cabin (10) is mounted on its cabin base (15) on an enclosure (50) including a circular sliding rail (51) mounted on the chassis (3) of the cabin (1) wherein the cabin opening (11) adopts a matching shape to the back of the seat (40) so that when the cabin opening (11) is positioned in front of the back of the seat (40), the inside of the cabin is closed and the cabin space protected from the weather outside.

2- Vehicle (1) cabin (10) according to claim 1 characterized by cabin characterized by a cabin (10) presenting a vertical axial symmetry with the cabin frame bottom section (13) mounted in the cabin base (15) until the height of the seat (40) being conical from the lower exterior cabin to the top, (13) is the cabin window (12), above the cabin window (12) a cylinder of conic conical widening down, covered by the cabin roof(14) taking the shape of a small dish in the top of the cone in order to protect the driver from rain and sun.

3- Vehicle (1) cabin (10) according to claim 1 characterized by a windshield wiper which can be incorporated in the cabin roof (14) which runs the perimeter of the glass cabin.

4- Vehicle (1) cabin (10) according to claim 1 characterized by the cabin opening (11) which takes almost the entire height of the cabin hood (10) and approximately one third of its periphery.

5- Vehicle (1) cabin (10) according to claim 1 characterized by a seat (40) that leaves storage space in its rear and that can be used for an electrical vehicle or a spare fuel tank.

6- Vehicle (1) cabin (10) according to claim 1 characterized by a steering (61) wheel (60) which is curved to match the cabin design and the cabin window curve.

7- Vehicle (1) cabin (10) according to claim 1 characterized by a cabin base (15) which can be rotated on a cabin enclosure (50), the driver positions the cabin enclosure (11) in the selected position selected for driving or for getting in or out or for parking in the closed position.

8- Vehicle (1) cabin (10) according to claim 1 characterized by the ergonomics of scooter seat positioning the head of the driver above the roof of traditional cars.
